(19) United States
(12) Patent Application Publication
(10) Pub. No.: US 2010/0300843 A1
(43) Pub. Date: Dec. 2, 2010

(54) LEG FOR A PROCESSING DEVICE, AND A METHOD FOR MEASURING THE POSITION OF A LEG

(75) Inventors: Timo Mustonen, Tampere (FI); Heikki Kylmala, Tampere (FI); Harri Niemi, Tampere (FI)

Correspondence Address: OLIFF & BERRIDGE, PLC, P.O. BOX 320850, ALEXANDRIA, VA, 22320-4850, US

(73) Assignee: METSO MINERALS INC., Helsinki (FI)

(21) Appl. No.: 12/809,268

(22) PCT Filed: Dec. 19, 2007
(86) PCT No.: PCT/FI2007/050711

§ 371 Date: Jun. 18, 2010

(51) Int. Cl. F16M 11/24; B65G 35/00; B07B 1/00; B02C 19/00

(52) U.S. Cl. 198/618; 248/157; 209/233; 241/101.01

(57) ABSTRACT

A leg and a method for measuring the position of a leg for a processing device, which leg comprises a first transfer member, which is articulated to the processing device and a second and a third transfer member for changing the position of the leg. The leg further comprises at least one measuring means for measuring the position of the leg in relation to the processing device.

### FIELD OF THE INVENTION

The invention relates to a leg for a processing device according to the preamble of the appended claim 1. The invention also relates to a method for measuring the position of a leg for a processing device according to the preamble of the appended claim 12.

### BACKGROUND OF THE INVENTION

Processing devices for mineral material are typically used for feeding, conveying, crushing, screening or washing mineral materials. Typically such a processing device comprises a frame and at least one processing unit suitable for processing mineral materials, for example a feeder, a belt conveyor, a crusher, a screen, or a corresponding device for transferring, refining or sorting mineral material. Often two or more processing units are integrated in the same frame, thus attaining a device suitable for versatile processing of mineral material.

Often such processing devices are designed so that they can be transported between different working sites or at least within one working site. Thus, the frame of a processing device for mineral material is often provided with runners, wheels or tracks. Mineral material processing devices are often also provided with an independent power source, for example a diesel engine that is connected to wheels or tracks underneath the frame, thus attaining a transferrable device that is capable of moving independently.

Finnish patent publication FI 109662 (corresponding U.S. Pat. No. 7,004,411) discloses a mobile processing device for mineral material, in which the processing units include a vibrating feeder, a jaw crusher, two belt conveyors and a magnetic separator. The device comprises a power source of its own, as well as tracks connected to the frame of the device, on which tracks the unit can be moved in a working site between different destinations.

Moving a track-mounted processing device for mineral materials on a working site is difficult. The processing device cannot be moved sideways, but transferring it sideways requires several forward and backward movements of the entire processing device. Similarly even a small change in the position of the front or back end of the frame requires forward and backward movements of the entire processing device.

In addition, the suitability for terrain of a track-mounted processing device for mineral materials is poor, because it must go around different obstacles, and therefore, it moves slowly in the working site. Thus, transferring the processing device from one location to another takes a long time.

In addition, solutions are known, where the processing device for mineral material is transferred in a working site with different leg-like transfer means. In U.S. Pat. No. 4,324,302 one leg has been mounted under the frame supporting the crusher, which leg comprises one vertically mounted first hydraulic cylinder. In addition, two other hydraulic cylinders are connected to the leg, which cylinders move the first hydraulic cylinder forwards and backwards, as well as sideways in relation to the frame. When transferring the crusher, its frame is slid by means of the leg along a base.

In U.S. Pat. No. 3,446,301 one leg for moving the crusher has also been mounted on the frame supporting a heavy device, such as a crusher or a conveyor. The leg comprises five vertically mounted first hydraulic cylinders, which are used for lifting the frame off the ground. In addition, four pairs of vertically acting hydraulic cylinders are connected to the leg, which cylinders move the leg forwards and backwards, as well as sideways in relation to the frame. The device is moved one step at a time by lifting the frame of the device off the ground and by moving it in the air for a transfer distance defined by the leg in the desired direction and by lowering the frame back to the ground.

DE publication 6601257 discloses a solution suitable for moving a crusher, where one leg based on a hydraulic cylinder is mounted to the frame of the crusher. In another disclosed embodiment there are three legs. Moving the crusher takes place one step at a time by transferring the frame a small distance at a time in the desired direction. The frame is lifted off the ground and lowered back down again at each step.

Transferring a heavy device by means of one leg is discontinuous, which slows down and complicates moving. The device must be lowered onto the ground between each step and the frame must be slid along the ground. The device is not suitable for terrain, but potholes and protrusions of the terrain can prevent the device from moving completely.

GB publication 1368050 shows a stepping mechanism for moving machines. The mechanism comprises several legs with four hydraulic cylinders. The first hydraulic cylinder is mounted vertically. In addition, three hydraulic cylinders are connected to this hydraulic cylinder, a second hydraulic cylinder and two supporting cylinders on opposite sides of the first cylinder. These three cylinders move the first hydraulic cylinder forwards and backwards, as well as sideways in relation to the frame. The ends of the piston rods of the supporting cylinders are arranged against a sliding surface, where they slide along the movement of the leg. The structure of such a leg is very complex, because a separate auxiliary sleeve must be mounted on the frame for the sliding surfaces of the side cylinders. In addition, the leg is not suitable for use in quarry conditions. The dust and dirt flying in quarry and other outdoor environments cause fouling of the sliding surfaces, which stops the leg from moving.

In addition to the solutions presented above, other devices for moving heavy working machines and loads are known, which devices comprise several hydraulically functioning legs. The vertical lengthening and shortening of the legs, as well as their movement sideways is implemented by hydraulic cylinders. This kind of devices are disclosed, for example, in patent publications U.S. Pat. No. 3,638,747, GB2017605 and DE 2129197. Moving the device takes place either by sliding it on the ground or by steps, where the frame is lifted off the ground and transferred for a short distance and then the frame is lowered back onto the ground. This uses unnecessary energy. Another problem of these solutions is that transferring the device is slow and complicated.

### BRIEF SUMMARY OF THE INVENTION

It is an aim of the present invention to provide a new leg for a processing device, which avoids the above-presented problems and whose position can be measured substantially continuously. It is also an aim of the invention to provide a method for measuring the position of a leg for a processing device.

To attain this purpose, the leg according to the invention is primarily characterized in what will be presented in the characterizing part of the independent claim 1.

The method according to the invention, in turn, is primarily characterized in what will be presented in the characterizing part of the independent claim 12.

The other, dependent claims will present some preferred embodiments of the invention.

The invention is based on the idea that a leg for a movable processing device comprises at least one measuring means for measuring the position of the leg of the processing device in relation to the frame. Several legs are articulated to the frame of the processing device and the processing device moves by means of them.

The legs comprise a first transfer member, which is vertically articulated to the frame of the processing device and it takes care of adjusting the length of the leg and its vertical movement. In addition, the legs comprise a second and a third transfer member for changing the position of the first transfer member.

Measuring means are arranged in each leg for measuring the angle between the first transfer member and the frame of the processing device. In addition, measuring means for measuring the position of the support plate of the leg touching the ground are arranged in each leg. On the basis of the measurements the position of the support plate can be determined, by means of which the movement of the leg can be controlled. In addition, the pressure caused by the support plate against the base is measured substantially continuously. The step height of the legs, i.e. how much the leg is lifted when taking a step, can also be adjusted.

When the processing device is moved, the legs carry the entire weight of the device and at the same time move the device. The legs are controlled so that the movement of the device resembles walking. At least four legs are attached to the frame of the processing device; preferably there are six or more legs. The legs are positioned in relation to the perimeter of the frame so that a steady and continuous movement of the device without lowering the frame onto the ground during movement, between steps, is possible. If the processing device is in a working position resting on the frame on a base, the frame of the device together with the devices connected to it is lifted off the ground by means of the legs before moving it. Thus, the first transfer members lift the processing device off the ground.

The structure of a leg according to the invention is simple. In addition, the legs according to the invention are very well suited for moving heavy loads, such as different work machines, for example, a processing device for mineral materials. By means of the legs, moving a processing device takes place by walking, as a result of which moving the processing device becomes faster. A walking processing device can be transferred significantly faster than with moving means according to prior art. The frame is not lowered down between steps, but the movement is continuous. Thus, the movement is steady and energy is also saved. The terrain-suitability of a walking processing device is also better than, for example, that of a track-mounted processing device. By means of the sensors arranged in the legs, the length of the legs and contact to the ground can be monitored, in which case the potholes and roughness of the terrain can be compensated by adjusting the length of the leg and the device can be kept in balance. By adjusting the length of the leg the processing device can be kept in balance, i.e. the frame is substantially horizontal even when it is moving up or down a slope.

An advantage of the invention is that when the position of the leg in relation to the frame is measured continuously, it is possible to determine from the measuring results the position the leg at each moment. On the basis of this the leg can be continuously controlled into a new position. The measurement also enables precise control of the movement of the leg, in which case the precise positioning of the processing device into a certain position is possible.

It is possible to move the legs in all directions by means of at least a second or a third transfer member. This way the processing device can also be transferred in all directions, sideways and cornerwise as well. In addition, the device can be rotated around any arbitrary point. This point can be located either in the midpoint of the device, in the material loading or discharge end of the device, or even outside the device.

### BRIEF DESCRIPTION OF THE DRAWINGS

In the following, the invention will be described in more detail with reference to the appended drawings, in which

FIG. 1 shows a schematical side view of a processing device for mineral material comprising legs for moving the device,

FIG. 2 shows the processing device of FIG. 1 from below,

FIG. 3 shows schematically a hydraulic leg in a front view,

FIG. 4 shows the leg of FIG. 5 in a top view, and

FIG. 5 shows a control unit in a schematic view.

### DETAILED DESCRIPTION OF THE INVENTION

In this description a processing unit refers to any processing unit suitable for processing different materials, such as a feeder, a belt conveyor, a crusher, a screen, or a corresponding device for transferring, refining or sorting material. Processing units used in recycling material, such as shredders and metal separators, belong to this group as well. The material being processed can be mineral material. The mineral material can be ore, broken rock or gravel, various types of recyclable construction waste, such as concrete, bricks or asphalt. The processed material can also be domestic waste, as well as wood, glass or metal.

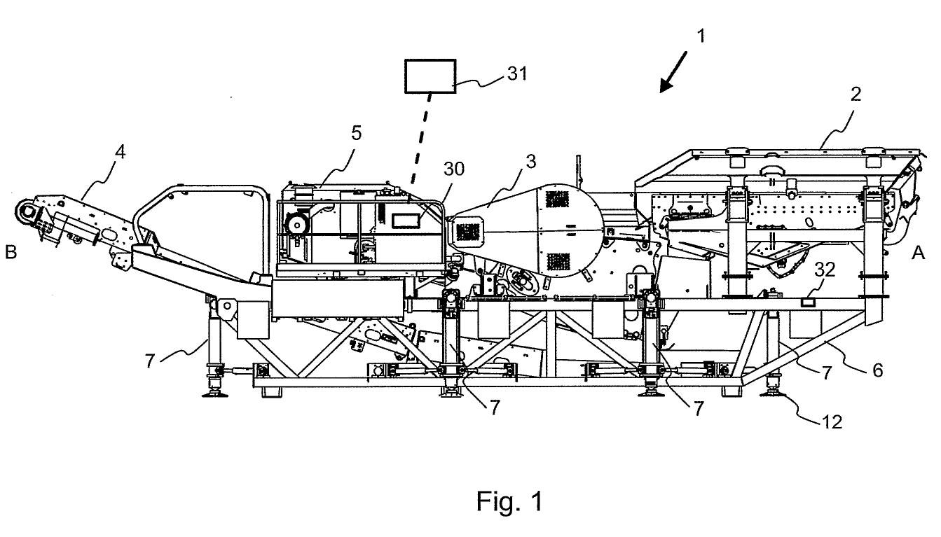

FIG. 1 shows a processing device 1 for mineral material comprising a feeder 2 for feeding material to a crusher 3 and a belt conveyor 4 for conveying the crushed product further away from the device. The crusher in the figure is a jaw crusher, but other types of crushers, such as a gyratory crusher, a cone crusher or a centrifugal crusher can be placed as parts of the processing device. In addition, the device comprises a power source 5, such as a diesel engine, which produces energy for the use of processing units.

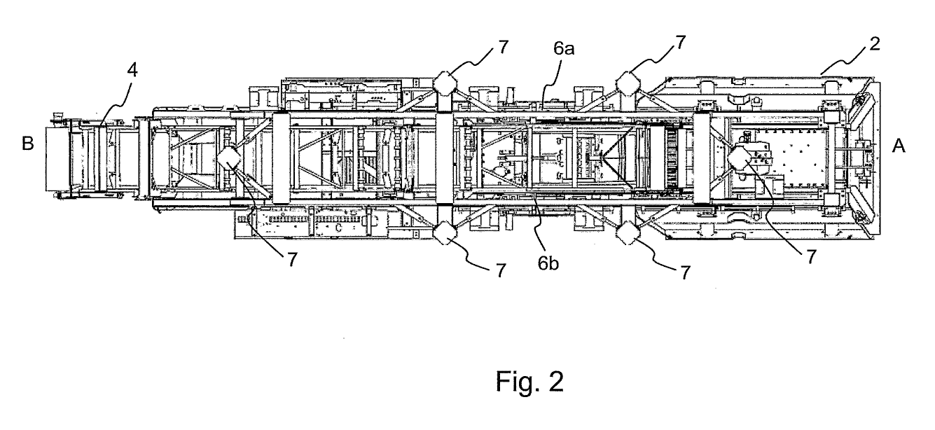

The feeder, crusher, power source and conveyor are attached to a frame 6. Legs 7 for moving the device are also attached in an articulated manner to the frame 6. In this embodiment there are six legs 7, as is shown in FIG. 2 as well. FIG. 2 shows the processing device from below, without the conveyor belt of the conveyor. The legs 7 are attached to the frame in relation to the center of gravity so that the frame 6 is substantially horizontal when the device is moved. The legs are placed in the frame 6 in relation to the processing device 1 so that one leg is in the front end A of the device, i.e. below the feeder 2, and one leg is in the back end B of the device, i.e. below the conveyor 4. The remaining four legs are placed on both sides of the frame in pairs so that the legs on opposite sides of the frame are at the same point in relation to the length of the frame. As can be seen in FIGS. 1 and 2, the legs 7 attached on the long sides 6a and 6b of the frame are attached on the outside of the frame. In an embodiment of FIG. 1 the processing device 1 is shown in a working position, where the frame is lowered onto a base, i.e. on the ground and the support plate 12 of the legs 7 has also been taken to the ground to support the device. In addition, the device comprises a control unit 30, whose operation is described more in detail later.

When transferring the processing device a part of the legs is always in a support stage, i.e. touching the ground, and a part in a transfer phase, i.e. off the ground and moving towards a new position. The predefined plan that defines how many legs are in the support and transfer phases is called a walking mode. For example, the possible walking modes of a processing device comprising six legs are a 5/6 mode, a 4/6 mode and a 3/6 mode. The first number refers to the number of legs in the support phase and the second number to the total number of legs. Thus, in the 5/6 mode the device comprises six legs, five of which are in the support phase, i.e. only one leg at a time is off the ground and moving towards a new position. In the 4/6 mode four legs are in the support phase and two legs in the transfer phase. Correspondingly, in the 3/6 mode three legs are in the support phase and three legs in the transfer phase. The greatest speed of moving is reached by this walking mode. If at least two legs are in the transfer phase, the movement of the legs can take place at different times with respect to each other, or the movement can be simultaneous. For example, the legs can move simultaneously in pairs. However, there must always be at least three legs in the support phase. Support and transfer phases follow each other at each leg. The legs in the support phase not only keep the device in balance, but also move the frame of the device to the desired direction. The legs in the transfer phase move in the air according to a path and direction of movement defined for them, until they are again lowered to the ground and they transfer to the support phase. During movement the legs are moved according to the selected walking mode. The number of legs mounted on the device and the desired speed of movement affect the selection of the walking mode.

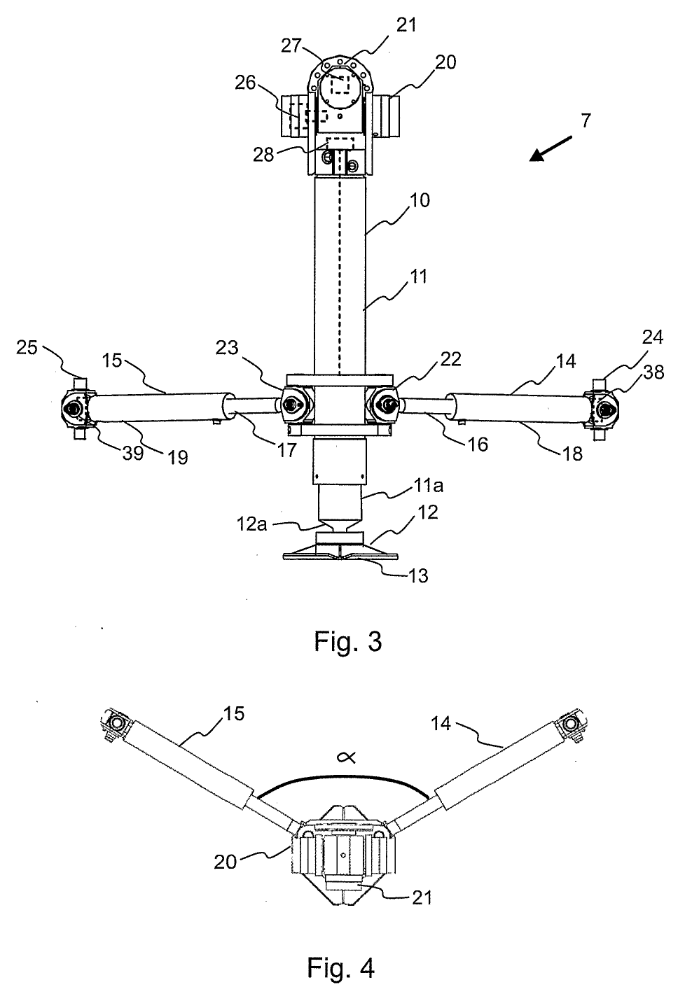

FIG. 3 shows a leg 7. This type of legs are also arranged in the processing device shown in FIGS. 1 and 2. The leg comprises a first transfer member 10, which is attached in an articulated manner in the frame of the processing device, substantially vertically. It is rigid in relation to its longitudinal axis and by means of it the length of the leg can be adjusted. It also carries the vertical forces of the device and the weight of the processing device when the processing device is moved or when the leg acts as a support leg when using the device. In this embodiment the transfer member is a hydraulic cylinder, but other longitudinally adjustable transfer members can also be used. The longitudinal movement can be created, for example, with a worm screw and an electric motor. This kind of an arrangement is called an electric cylinder as well.

In the figure the first hydraulic cylinder is shown in a position where a part of a transfer arm 11a of the cylinder is outside a cylinder chamber 11. A support plate 12 is attached to the lower end of the transfer arm of the first hydraulic cylinder 10, the lower surface of which plate, i.e. a support surface 13, touches the ground when the leg 7 is in the support phase. The support surface 13 can have, for example, a square-like shape with side lengths of 350 mm×350 mm. The area of the support surface 13 is dimensioned according to the type of base of the working site. The weight of the processing device is also taken into account in the dimensioning. The support plate 12 is attached to the end of the transfer arm of the first hydraulic cylinder with a fastening means 12a, which enables the tilting of the support plate in relation to the transfer arm. For example, a ball joint can be used as the fastening means. The first hydraulic cylinder is articulated to the frame 6 of the processing device by means of a first and a second articulation 20 and 21 arranged in the upper end of the cylinder chamber 11.

In addition, the leg comprises two transfer members 14 and 15, in this embodiment two hydraulic cylinders for moving the first hydraulic cylinder 10. The transfer members 14 and 15 can also be other types of longitudinally adjustable transfer members, such as the aforementioned electric cylinders. The second and third hydraulic cylinder 14 and 15 are articulated to the first hydraulic cylinder 10 substantially horizontally and on the same level with each other. They are articulated from one end to the first cylinder and from the other end to the frame 6 of the processing device in the following manner: the transfer arms 16 and 17 of the second hydraulic cylinder 14 and the third hydraulic cylinder 15 are attached by means of a third articulation 22 and a fifth articulation 23 to the lower part of the cylinder chamber 11 of the first hydraulic cylinder, within a distance from the lower end of the cylinder chamber. Their ends on the side of the cylinder chamber 18 and 19 are, in turn, articulated to the frame 6 of the processing plant by means of a fourth articulation 24 and a sixth articulation 25. The second and third hydraulic cylinder 14 and 15 create the sideways movement of the leg 7. The movement of the leg 7 created by the hydraulic cylinders 14 and 15 comprises both a horizontal and a vertical component, whose size varies depending on the desired path of movement. In other words, the path of movement of the support plate can be arch-like or take place on the horizontal plane only. The first hydraulic cylinder 10 is larger in size and in its cylinder capacity than the second and third hydraulic cylinder 14 and 15.

FIG. 4 shows the leg 7 of FIG. 3 in a basic position seen from above. As can be seen in the figure, the second and third hydraulic cylinder 14 and 15 are attached to the first hydraulic cylinder 10 so that an angle α is formed between them. The size of the angle α depends on several factors, for example, on the fastening point of the cylinders 14 and 15 to the frame 6, the dimensions of the processing apparatus, the length of the cylinders 14 and 15, and the diameter of their cylinder chambers, as well as the required horizontal powers. These factors are selected so that the desired step box is created.

Measuring means, i.e. sensors, are arranged in the leg 7, for defining the position of the leg, i.e. the position of the first hydraulic cylinder and the position of the support plate in relation to the frame substantially continuously. Inside a first articulation 20 and a second articulation 21 are arranged first measuring means, i.e. two angle sensors 26 and 27, with which the angle position of the support plate 12 in relation to the frame is measured. In addition, inside the cylinder chamber of the first cylinder 10 is arranged a second measuring means 28, such as a linear sensor for measuring the vertical position of the support plate 12 in relation to the frame. Thus, the linear sensor measures the magnitude of the vertical movement of the first cylinder 10. For example, a magnetostrictive sensor can be used as a linear sensor. The second measuring means can also be an optical measuring means, such as a measuring device based on a laser or image processing. In addition, measuring devices based on acoustic methods as well as magnetic field measuring, such as an ultrasound sensor or an eddy current sensor can be used. By means of these three sensors 26, 27 and 28 the position of the support plate 12 and the leg 7 in relation to the frame can be defined. The first measuring means 26 and 27 as well as the second measuring means 28 are shown in FIG. 3 with dashed lines.

Measuring means 38 and 39 arranged in the hydraulic cylinders 14 and 15 can also function as first measuring means, which may have the same operating principle as the above-mentioned measuring means 28. By means of them the length of at least on of the hydraulic cylinders 14 and/or 15 is measured, from which length it is possible to determine the angle position of the hydraulic cylinder 10 and further the position of the support plate 12 in relation to the frame.

In addition, the pressure prevailing in the cylinder chamber of the first hydraulic cylinder 10 is measured. The measurement takes place by means of a pressure sensor 29. The pressure sensor is arranged either directly in the cylinder chamber or it is arranged in a duct conveying pressure medium into the cylinder chamber. On the basis of pressure measurements it is possible to determine the pressure caused by the support plate 12 against the base and to ensure that the force the support plate 12 touches the ground with is sufficient. The sensors perform measurements substantially continuously and by means of the measurements the position of the support plate 12 in both the transfer and support phase can be determined continuously. In addition, the position of the frame in relation to the base is measured with an inclination sensor 32 (shown in FIG. 1). The inclination sensor can be, for example, an inclinometer. The measurement signals measured by the sensors are sent to a control unit 30 placed in the processing device. The control unit 30 controls the movement of the processing device according to commands provided by the user of the processing device, which commands are sent to the control unit 30 with a user interface 31 connected to it. The user interface can be, for example, a joy-stick-type interface based on wireless signal transfer, or a keyboard. Thus, a transmitter is arranged in the user interface for transmitting control commands to the control unit, and a receiver is arranged in the control unit for receiving them. In the figure the wireless data transfer is illustrated by a dashed line. In addition, the user interface 31 may be connected to the control unit 30 by a cable.

The measurement signals measured by the measuring means, i.e. the angle sensors 26 and 27, the linear sensor 28, the pressure sensor 29 and the inclinometer 32, can be directed to the control unit 30 either via cables or wirelessly. If the measurements are transmitted to the control unit wirelessly, the measuring means are provided with a transmitter for transmitting measurement results, and the control unit is provided with a receiver for receiving measurement signals. The control unit forms control commands to the legs and the hydraulic cylinders in them on the basis of the measurement signals. The control commands produced by the control unit can also be conveyed to the legs either via cables or wirelessly. If the control commands are transmitted to the legs wirelessly, such as via radio waves or infrared radiation, the control unit is provided with a transmitter for transmitting control commands and the legs are provided with a receiver for receiving control commands.

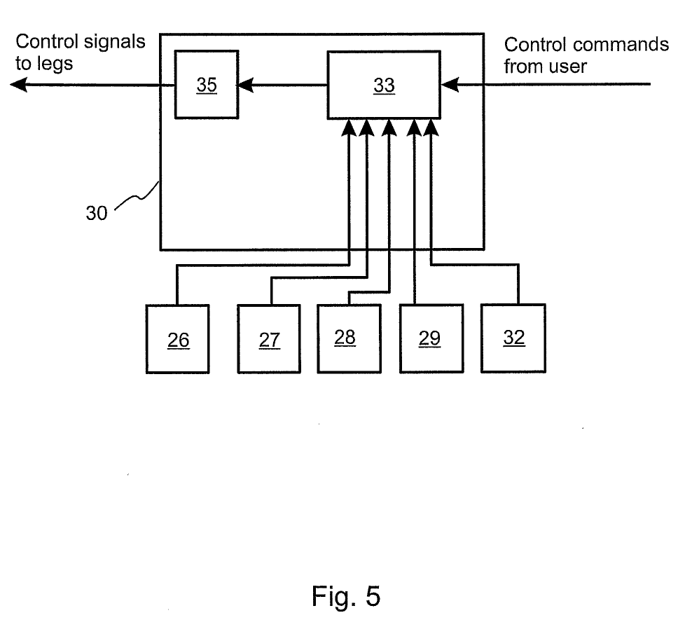

The control unit 30 comprises means for performing the operations of the method according to the invention. FIG. 5 shows more closely a control unit 30, which includes means 33 to 35 for calculating and determining the parameters necessary for moving the process device, as well as for determining the control signals. The steps of the above-described method can be performed by a program, for example by a micro processor. The means may be composed of one or more microprocessors and the application software contained therein. In this example, there are several means, but the different steps of the method can also be performed in a single means.

The control unit 30 comprises calculating means 33, which receive the data concerning the desired walking mode and the direction and speed of movement of the processing device sent by the user of the processing device. The calculating means 33 also receive the measurement signals measured by the measuring means 26, 27, 28, 29 and 32 and on the basis of them and the selected walking mode they calculate a step diagram for each leg 7 and on the basis of that determine their next path and direction of movement. Determining the path and direction of movement of the legs also takes into account the so-called step box, i.e. a cubic capacity in square space, where the support plate 12 can move within the limits set by the cylinders.

The paths and directions of movement determined for each leg by the calculating means 33 are transmitted to control signal formation means 35 in the control unit, which means form control commands for each hydraulic cylinder 10, 14 and 15 of each leg 7.

As was stated above, the control unit 30 comprises means for controlling the movement of the legs. The control unit may also comprise means for controlling the process itself, such as the operation of a crusher, conveyor or the like.

When taking a step, the hydraulic cylinders of the leg in the transfer phase operate in the following manner: first, the support plate 12 of the leg is lifted off the ground by means of the first cylinder 10, by pulling the transfer arm of the first cylinder inside the first cylinder chamber 11. How high the support plate 12 of the leg is lifted depends on the desired height of the step. After this the second and/or third cylinder 14 and 15 move the first cylinder 10 to the desired direction by pushing and/or pulling the transfer arms 16 and 17 of the cylinders from the cylinder chambers/to the cylinder chambers 18 and 19, until the desired direction of the step is reached. Finally, the first hydraulic cylinder lowers the support plate 12 of the leg back to the ground by pushing the transfer arm 11a of the first cylinder outwards from the first cylinder chamber. Naturally the operations of the first hydraulic cylinder and the second and/or third hydraulic cylinder can take place simultaneously as well. The legs in the support phase move the frame of the processing device towards the desired direction continuously; it is not lowered to the ground between steps. The length of the step, and at the same time the transfer speed of the device is controlled with the control system.

The invention is not intended to be limited to the embodiments presented as examples above, but the invention is intended to be applied widely within the scope of the inventive idea as defined in the appended claims.

1. A leg for a processing device, wherein the leg comprises:
a first transfer member, wherein the first transfer member is attachable in an articulated manner to a frame of the processing device, and wherein the first transfer member comprises a cylinder chamber and a transfer arm for carrying the weight of the processing device and adjusting the length of the leg; and
a second transfer member for changing the position of the first transfer member and for moving the processing device;
at least one measuring means for measuring the position of the leg in relation to the frame; and
a pressure sensor for measuring the pressure prevailing in the cylinder chamber.

2. The leg according to claim 1, wherein the leg further comprises at least one first measuring means, which is arranged to measure the position of the first transfer member in relation to the frame.

3. The leg according to claim 2, wherein the first measuring means comprises an angle sensor arranged to measure the angle between the first transfer member and the frame.

4. The leg according to claim 1, wherein the first transfer member is provided with a support plate settable against a base, e.g. the ground, and the leg further comprises a second measuring means for measuring the position of the support plate in relation to the frame.

5. The leg according to claim 1, wherein the first transfer member is substantially vertical.

6. The leg according to claim 1, wherein the leg further comprises a third transfer member, wherein one end of the second transfer member and the third transfer member are attached from one end to the first transfer member and from the other end attached to frame of the processing device.

7. The leg according to claim 2, wherein the first measuring means comprises a linear sensor arranged to measure the length of the second transfer member.

8. The leg according to claim 6, wherein the second transfer member and the third transfer member are articulated to the first transfer member, wherein the second transfer member and the third transfer member are substantially horizontal and located on a same level in relation to each other.

9. The leg according to claim 1, wherein the leg comprises a first articulation and a second articulation in an end of the cylinder chamber, wherein the first transfer member is articulated by means of the first and the second articulations to the frame, and wherein a support plate settable against a base, e.g. the ground is located in an end of the transfer arm.

10. The transfer leg according to claim 9, wherein the second transfer member comprises a cylinder chamber and a transfer arm, the third transfer member comprises a cylinder chamber and a transfer arm, the leg comprises a third articulation in an end of the transfer arm of the second transfer member, a fourth articulation in an end of the cylinder chamber of the second transfer member, a fifth articulation in an end of the transfer arm the third transfer member, and a sixth articulation in an end of the cylinder chamber of the third transfer member, wherein the second transfer member is articulated by means of the third articulation to the lower end of the first cylinder chamber and by means of the fourth articulation to the frame, and wherein the third transfer member is articulated by means of the fifth articulation to the lower end of the first cylinder chamber and by means of the sixth articulation to the frame.

11. The leg according to claim 1, wherein the processing device is at least one of the following: a feeder, a crusher, a screen, a shredder, or a separator.

12. A method for a leg for a processing device, wherein the leg comprises:
a first transfer member, wherein the first transfer member is attached in an articulated manner to a frame of the processing device, and wherein the first transfer member comprises a cylinder chamber and a transfer arm carrying the weight of the processing device and adjusting the length of the leg,
a second transfer for changing the position of the first transfer member and for moving the processing device;
wherein the method comprises:
measuring the position of the leg in relation to the frame with at least one first measuring means; and
measuring the pressure prevailing in the cylinder chamber with a pressure sensor.

13. The method according to claim 12, wherein the method further comprises measuring the position of the first transfer member in relation to the frame with at least one first measuring means.

14. The method according to claim 13, wherein the method further comprises measuring the angle between the first transfer member and the frame.

15. The method according to claim 12, wherein the leg is provided with a third transfer and that member and the length of the second and the third transfer member is measured.

16. The method according to claim 12, wherein the first transfer member is provided with a support plate settable against a base, e.g. the ground, and the position of the support plate in relation to the frame is measured.

17. The method according to claim 12, wherein the processing device is at least one of the following: a feeder, a crusher, a screen, a shredder, or a separator.

18. A processing device having a frame and at least one processing unit for processing mineral material, wherein the processing unit is attached to the frame, and wherein the processing device further comprises at least four legs, wherein each leg comprises:
a first transfer member, wherein the first transfer member is attachable in an articulated manner to the frame of the processing device, and wherein the first transfer member comprises a cylinder chamber and a transfer aim for carrying the weight of the processing device and adjusting the length of the leg;
a second transfer member for changing the position of the first transfer member and for moving the processing device;
at least one measuring means for measuring the position of the leg in relation to the frame; and
a pressure sensor for measuring the pressure prevailing in the cylinder chamber.

19. The processing device according to claim 18, wherein the processing device further comprises an inclination sensor for measuring the position of the frame in relation to a base, e.g. the ground.

20. The processing device according to claim 18, wherein the processing unit is a feeder, a crusher, a screen, a shredder, or a separator.
